(19) United States
(12) Patent Application Publication
(10) Pub. No.: US 2024/0085884 A1
(43) Pub. Date: Mar. 14, 2024

(54) SYSTEM FOR PROCESS ABNORMALITY RECOGNITION AND CORROBORATION

(71) Applicant: TRIAD National Security, LLC., Los Alamos, CA (US)

(72) Inventors: Vlad Henzl, Los Alamos, NM (US); Rollin Evan Lakis, Los Alamos, NM (US); Emily Stark Teti, Los Alamos, NM (US)

(21) Appl. No.: 18/243,564

(22) Filed: Sep. 7, 2023

Related U.S. Application Data
(60) Provisional application No. 63/404,782, filed on Sep. 8, 2022.

(51) Int. Cl. G05B 19/4155; H04L 9/40

(52) U.S. Cl. CPC G05B 19/4155; H04L 63/1425; G05B 2219/32404

(57) ABSTRACT

A system includes a plurality of non-intrusive sensors, an access point device, and a computing device. The non-intrusive sensors are configured to monitor activities associated with one or more devices, wherein at least one non-intrusive sensor of the plurality of non-intrusive sensors is positioned within a physical vicinity of the one or more devices. The access point device is communicatively coupled to the plurality of non-intrusive sensors, wherein the access point device is configured to receive data associated with the monitored activities from the plurality of non-intrusive sensors and further to transmit the data associated with the monitored activities to a computing device for processing. The computing device is configured to receive the data associated with the monitored activities and process the data to determine an anomaly associated with the one or more devices.

### RELATED APPLICATIONS

The instant application is a nonprovisional U.S. application that claims the benefit and priority to the U.S. Provisional Application No. 63/404,782 filed on Sep. 8, 2022, which is incorporated herein by reference in its entirety.

### FEDERALLY SPONSORED RESEARCH OR DEVELOPMENT

The United States government has rights in this invention pursuant to 89233218CNA000001 between the National Nuclear Security Administration (Department of Energy) and Triad National Security, LLC for operation of Los Alamos National Laboratory.

### BACKGROUND

Automation has become prevalent in recent years and even more so in industrial settings. Use of supervisory control and data acquisition system (SCADA) has enabled many industries to automate and remotely control various processes through cyber requests. For example, various processes for nuclear power-plant, natural gas distribution hub, power grid, water treatment plant, car manufacturing facility, petroleum processing facility, chemical plants, semiconductor processing facility, etc., may be automated and remotely controlled by an operator using SCADA. In general, SCADA may be used by an operator to control various processes from a centralized location, e.g., fill a tank, open/close a valve, turn on/off a piece of machinery, control process parameters, etc. In other words, SCADA is a system of intrusive and active elements that enables the operator to control, manipulate, or modify one or more processes within an industrial setting.

However, designing and implementing SCADA for complex industrial or production environment may take years or even decades and is a costly process. As such, modifying SCADA over time as technology evolves, operator needs change, or new process vulnerabilities are recognized, is not only difficult and time-consuming but it may also be cost prohibitive as it may require a shutdown of the entire facility. Moreover, facility unique SCADA can be difficult to scale given the amount of time required to design SCADA upgrade as well as implement its modification.

Additionally, in recent years, various industrial processes such as SCADA have become a prime target for wrong doers to launch cyber hacking, cyber hijacking, ransomware attacks, cyber espionage, etc. Efforts have been made in protecting critical infrastructure control systems from malicious attacks, e.g., by air-gaping of the system control network, anti-virus software, cyber security solutions, etc. Unfortunately, most solutions do very little once an attacker has succeeded in penetrating the system. In some cases, the operator may be unaware that SCADA has been compromised, e.g., an attacker may freeze the display of parameters with the expected parameters giving the operator the illusion that the system is functioning as planned or purposefully display artificial data again creating an illusion that process has not been interfered with. Unfortunately, there are typically no real time, independent, and non-intrusive verification systems available to an operator to detect that a process has been compromised or that it is not functioning properly and as expected or providing real time verification of the process ground truth when SCADA becomes compromised or incapacitated.

### SUMMARY

Accordingly, a need has arisen to independently verify information provided by SCADA and/or to determine whether the system is operating as it should and whether the system has been compromised. For example, in some embodiments a System for Process Abnormality Recognition and Corroboration (SPARC) can independently verify data provided by SCADA. In some embodiments, the SPARC is flexible, adaptable, scalable, and deployable through self-assembly of intelligent network of non-intrusive sensors configured to identify process anomalies indicative of equipment failure, human error, or deliberate malicious acts in real time. The sensors which are an inherent part of SPARC in some embodiments, independently monitor operations and parameters of various processes, e.g., opening/closing a valve, changing temperature settings, starting/turning off pump, filling/emptying a tank, turning a machinery on/off, etc. The monitored operation may be provided to an operator that can determine whether the system is functioning properly, compare it to information from SCADA, and/or determine whether the system has been compromised.

Thus, use of a network of independent sensors of the SPARC to collect on the ground data can be leveraged to determine whether the system and/or the data provided by SCADA is compromised, whether the system is functioning as it should, etc., by independently monitoring the ground truth. In other words, SPARC is a central hub that is configured to acquire data that is processed in order to identify one or more anomalies in a system. As such, SPARC creates yet another layer of defense in case of a successful attack in breaching the primary defense lines of a system by providing the operator the ability to monitor the ground truth of the unfolding events and/or to enable the operator to take the necessary steps in mitigating the damage and interfere against the intruder. In some embodiments, the SPARC may be used as a diagnostic system to predict and subsequently verify the operation of the system (e.g., using machine-learning (ML) modeling) and to provide early, real-time warning associated with anomalous conditions currently unfolding, e.g., prohibited access, unusual operation such as opening/closing a valve, etc., or deviation(s) from the predicted operation. It is appreciated that the early and/or real-time warning may be used to predict subsequent failures and/or steps that may be taken by an intruder, as an example.

In other words, SPARC is a system used to understand the relationship between cyber requests and reported through SCADA (as an example) and the physical boundary (i.e., eyes on the ground with respect to events occurring) in the system. As such, SPARC may be used to detect internal inconsistencies of SCADA that may be indicative of certain anomalies, e.g., cyber-attack, etc. Additionally, SPARC may be viewed as an additional security that complements the SCADA system to identify anomalies that may need to be addressed.

These and other features and aspects of the concepts described herein may be better understood with reference to the following drawings, description, and appended claims.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A depicts an example of a System for Process Abnormality Recognition and Corroboration (SPARC) according to one aspect of the present embodiments.

FIG. 1B depicts an example of a System for Process Abnormality Recognition and Corroboration (SPARC) according to another aspect of the present embodiments.

FIG. 2 depicts an example of a SPARC associated with a water treatment facility according to one aspect of the present embodiments.

FIGS. 3A-3C show an example of monitored ground truth in a water treatment facility according to one aspect of the present embodiments.

FIGS. 4A-4C show a detailed example of the monitored ground truth of FIGS. 3A-3C according to one aspect of the present embodiments.

FIGS. 5A-5D show yet another example of monitored ground truth in a water treatment facility according to one aspect of the present embodiments.

FIGS. 6A-6B show an example of monitored ground truth associated with different processes in a water treatment facility according to one aspect of the present embodiments.

FIGS. 7A-7B show an example of monitored ground truth (On/Off) associated with one process in a water treatment facility according to one aspect of the present embodiments.

FIGS. 8A-8B show another example of monitored ground truth (On/Off) associated with another process in a water treatment facility according to one aspect of the present embodiments.

FIGS. 9A-9C illustrate the machine learning regime including learning a sensor-level network (9A-9B) and a portion of a system-level network used to detect anomalies according to one aspect of the present embodiments.

FIG. 10 illustrates a flow diagram for processing data in a SPARC system according to one aspect of the present embodiments.

FIG. 11 is a block diagram depicting an example of a computer system suitable for processing data in a SPARC system in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing certain concepts, and the terminology is not intended to be limiting. Unless defined otherwise, all technical and scientific terms used herein have the same meaning as commonly understood in the art to which the embodiments pertain.

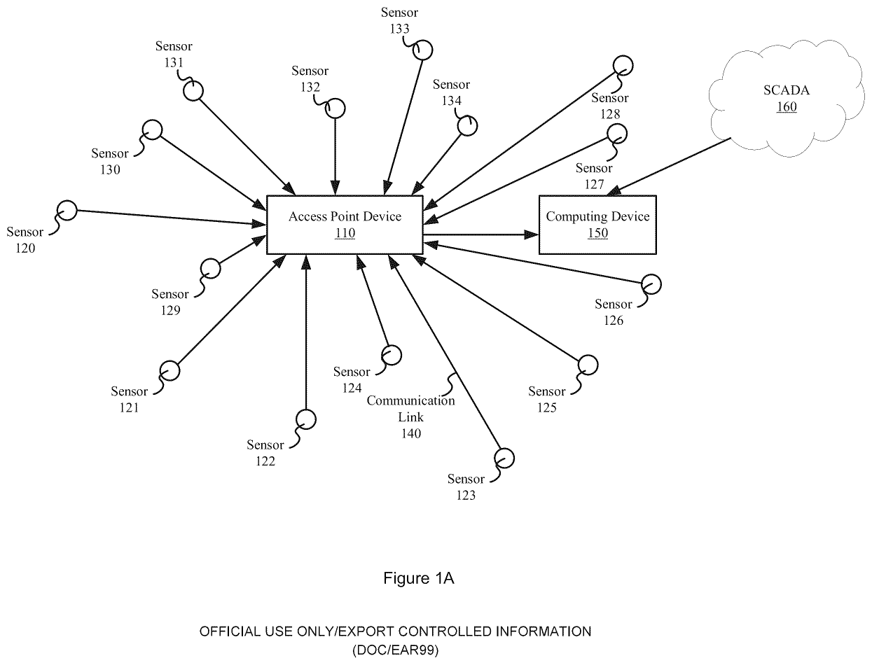

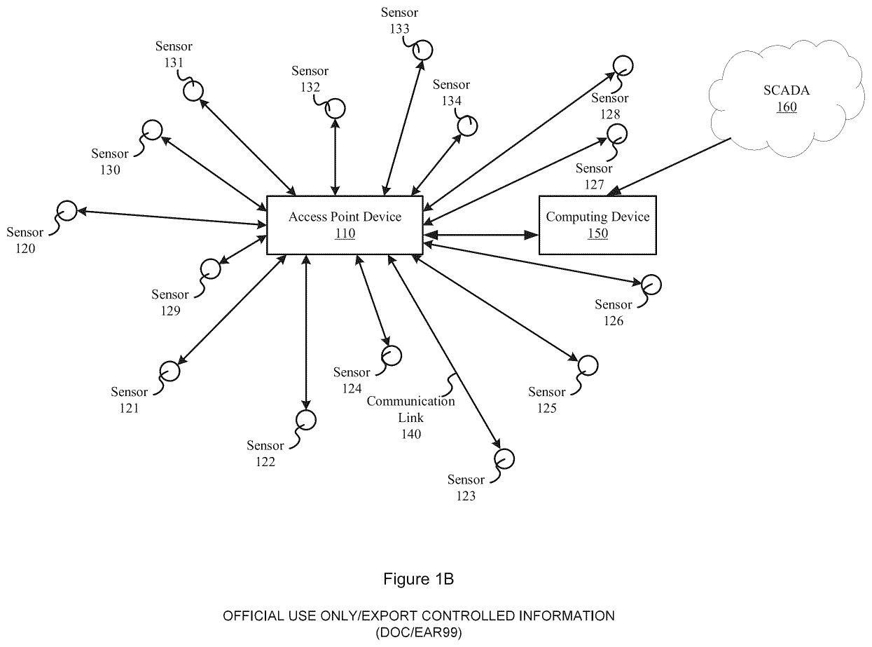

As described above a need has arisen to independently verify information provided by SCADA and/or to determine whether the system is operating as it should and/or in the event of unfolding attack monitor the intruder's action. Moreover, a need has arisen to determine whether the system has been compromised. In some embodiments, a network of non-intrusive sensors is used in a SPARC system to independently verify data provided by SCADA and/or determine anomalies associated with one or more processes of a system and/or determine whether the system has been compromised. In some embodiments, the SPARC is flexible, adaptable, scalable, and deployable through self-assembly of intelligent network of non-intrusive sensors configured to identify process anomalies or deliberate malicious acts in real time. The sensors in some embodiments, independently monitor operations of various processes, e.g., opening/closing a valve, changing temperature settings, opening/closing pump, filling/emptying a tank, turning a machinery on/off, etc. The monitored operation may be provided to an operator that can determine whether the system is functioning properly, compare it to information from SCADA (e.g., comparing data and whether the difference exceeds a particular threshold), determine whether the system has been compromised and/or provide real time information about the unfolding attack. In some embodiments, the non-intrusive sensors are not connected to any control features of the system and may not provide input to control feedback loops or other elements used to control a process. In other words, the non-intrusive sensors are passive in nature and do not control any aspect of a process for the system, e.g., water treatment facility as an example. Thus, the sensors, in some embodiments, may simply monitor operations without actually controlling any aspect of a process, thus not providing any additional process vulnerability exploitable by an intruder. In other words, SPARC is a central hub that is configured to acquire data from one or more passive and nonintrusive sensors, which is subsequently processed in order to identify one or more anomalies in the system. It is appreciated that the sensors that are discussed throughout the application in FIGS. 1A-9 are non-intrusive and passive in nature, thereby do not control any aspect of a process.

It is appreciated that in some embodiments, the network of sensors, complemented by customized machine-learning algorithms, enables an operator to monitor the ground truth (on the grounds data (i.e., data associated with unfolding events on the ground) associated with the system), which is essentially at the intersection of cyber control and physical actuation (i.e., turn on a pump, change a temperature setting, close a valve etc.). In other words, SPARC can provide real-time monitoring of the process-state, regardless of whether SCADA has been compromised or disabled, i.e., independent of SCADA. SPARC according to some embodiments may provide monitoring data from a time period prior to the initial failure to the initial failure time period and beyond, thereby providing events data leading to one or more failures or intrusions. Accordingly, the system operator may be provided with early warning signs, e.g., system failure, system intrusion, etc., and therefore may take appropriate actions. In other words, SPARC is a system used to understand the relationship between cyber requests and reported through SCADA (as an example) and the physical boundary (i.e., eyes on the ground with respect to events occurring) in the system. As such, SPARC may be used to detect internal inconsistencies of SCADA that may be indicative of certain anomalies, e.g., cyber-attack, etc. Additionally, SPARC may be viewed as an additional security that complements the SCADA system to identify anomalies that may need to be addressed.

It is appreciated that in some embodiments where the failure or event is primarily cyber hijacking or physical incapacitation of the SCADA, SPARC remains physically and informationally isolated, and continues its core monitoring functionality. It is appreciated that while SCADA may be effectively compromised or disabled, SPARC can still provide real time monitoring of the unfolding events, giving the operator an additional line of defense because SPARC is a network of passive and non-intrusive sensors deployable, thus SPARC does not create any new attack opportunity or process vulnerability. SPARC may in embodiments include singular/primitive sensors that monitor each process element implicitly through one or more physical observables, e.g., vibration, humidity, temperature, acceleration, position, intensity of electric or magnetic field, etc., as opposed to intrusively as it is done in SCADA. As an example, a vibration sensor can be mounted on a pump to sense vibrations when the pump is ON, or only low, background vibrations when the pump is OFF. In one nonlimiting example, a thermocouple sensor may be mounted on a tank to sense ambient temperature when the tank is empty, and when the temperature increases/decreases as the tank is filled with some liquid. Furthermore, the likelihood of compromising both SCADA and SPARC simultaneously is low due to use of different hardware/software platforms that are air-gaped from one another, thus creating an early warning to the operator as soon as deviation between SCADA and SPARC is detected.

It is appreciated that a SPARC unlike SCADA can be quickly, i.e., in minutes or hours, reconfigured, amended or expanded to address any newly identified threat modalities or gaps in the operator's monitoring capabilities. Moreover, it is appreciated that while SPARC does not explicitly protect the facility from cyber-intrusion attempts or acts of a rogue insider, the SPARC does provide an early warning by identifying one or more anomalies.

It is appreciated that SPARC can also be used in facilities where independent verification of the data declared by an operator may be needed. For example, in nuclear facilities and for safeguarding against nuclear disasters, an independent verification, e.g., independent regulator such as International Atomic Energy Agency (IAEA), may be needed to verify the operator declared type of activities. SPARC can be used for this independent verification in order to rule out possible misuse of nuclear material for non-civilian purposes as well as for other reasons.

It is appreciated that in addition to the advantages described above, data provided by SPARC may be used by advanced data-analytics algorithms to identify parameters that are not under control or that may be hidden/unknown correlations of different process states. For example, advanced data-analytics algorithms may process data captured by SPARC to identify dependencies of various process parameters on one another that originally were not considered as dependent from one another. In other words, SPARC can be used to further understand the system and therefore improve the quality of the process.

Referring now to FIG. 1A, depicts an example of a SPARC according to one aspect of the present embodiments. In some embodiments, a network of non-intrusive sensors 120-134 may be used to monitor and collect data implicitly through physical observation and/or physical collection and transmit the collected monitored data to an access point device 110 via one or more communication link(s) 140, e.g., Wifi, Bluetooth, wired, etc. The access point device 110 may create a wireless local area network (WLAN) in some embodiments. However, it is appreciated that the access point device 110 may create a network that includes wired components or a combination of wired and wireless components.

It is appreciated that in some embodiments, at least one sensor from the non-intrusive sensors 120-134 may include sensors that sense position, presence, and/or proximity. In yet some nonlimiting examples, at least one sensor from the sensors 120-134 may include sensors that sense motion, velocity, and/or displacement. According to some embodiments, at least one sensor from the sensors 120-134 may sense one or more of temperature (or temperature change), humidity/moisture, acoustic/sound vibration, chemical/gas sensing, liquid flow, force/load/torque/strain/pressure, leaks, threshold levels, electric charges/fields, magnetic fields, acceleration, tilt, optical sensing (e.g., ambient light), radiation sensing, etc. It is appreciated that the sensors 120-134 may be coupled to various components within a facility (e.g., components in the facility used during a process) in a non-intrusive manner. For example, a sensor configured to sense vibration may be coupled (e.g., mechanically coupled) to a pump to detect vibration, e.g., detecting more vibration may indicate that the pump is running while less vibration may indicate that the pump is off. In yet another example, a sensor configured to sense position, presence, proximity, motion, displacement, etc., may be positioned within a facility and it may utilize infrared technology to determine whether a person is present or whether a component used in a process within a facility has moved. In yet another nonlimiting example, a sensor configured to sense magnetic and/or electric fields may be placed in a particular vicinity of a process element to monitor magnetic/electrical fields in a non-intrusive fashion. In yet another nonlimiting example, a sensor configured to sense acoustic/sound vibration may be placed within a proximity of a process element in a facility, e.g., within a room, coupled to a pipe, etc., to detect acoustic vibration, e.g., by using a microelectromechanical systems (MEMS) technology. In other words, the sensors may be deployed in a non-intrusive manner to collect data.

The collected data from the sensors 120-134 may be transmitted to the access point device 110 that is communicatively coupled to a computing device 150. It is appreciated that in this nonlimiting example, the data collected by the sensors 120-134 are communicated via a one-way communication link to the access point device 110 and subsequently via a one-way communication link to the computing device 150. In this nonlimiting example, the sensors 120-134 and/or the access point device 110 are immune from cyber-attack because they are configured for a one-way communication as opposed to a bidirectional communication, thereby preventing a potential intruder (e.g., cyber attacker) from changing or configuring the sensors 120-134 and/or the access point device 110. The computing device 150 may render the collected data from the sensors 120-134 to the operator of the facility. The collected data from the sensors 120-134 serves as an independent verification system to data processed and/or provided by SCADA 160. For example, in some embodiments, the operator may monitor data provided by the SPARC system (i.e., network of non-intrusive sensors 120-134 via the access point 110) to determine whether the system or a process within the system is functioning as expected. If one or more anomalies are detected, then the operator may take steps to address the anomalies. In some embodiments, the monitored data by the SPARC may be compared to data provided by SCADA 160 to identify any anomalies. In a cyber-attack example, the data provided by SCADA 160 may indicate that the system is operating as expected while on the ground data provided by the SPARC may indicate otherwise, enabling the operator to take necessary steps to address the issue. It is appreciated that in this nonlimiting example, the SCADA 160 also provides its respective data to the computing device 150 in a one-way link, thereby preventing a potential attacker from configuring the SCADA 160 through the computing device 150.

It is appreciated that the network of non-intrusive sensors coupled to an access point to create a SPARC is advantageous because it is not only flexible, scalable, and expandable but its deployment is much faster and less costly, e.g., minutes to hours to deploy, in comparison to design and implementation of SCADA or modification thereof that may be months, years or decades. For illustrative purposes only that should not be construed as limiting the scope of the embodiments, a SPARC deployed in a water treatment facility is described. As such, other types of sensors and configurations may be used in other types of facilities, e.g., power generation facility, nuclear facility, manufacturing facility, etc., to monitor operation of one or more processes in the facility in a non-intrusive fashion. The monitored information may be used to identify one or more anomalies, e.g., defects, cyberattack, etc., which enables an operator to take necessary step(s) in addressing the issue(s).

FIG. 1B is substantially similar to that of FIG. 1A except that the communication link between sensors 120-134, the access point device 110, and the computing device 150 is a bidirectional communication link. The bidirectional communication of FIG. 1B is merely to illustrate that the sensors 120-134 and the access point device 110 may be communicated with, e.g., sending a ping signal, sending a health request signal to receive a response from a sensor regarding its health and battery, etc. However, the sensors 120-134 and/or the access point device 110 are not configurable using a bidirectional communication link, thereby preventing a potential intruder from attacking or configuring the manner by which the sensors 120-134 and/or the access point device 110 function.

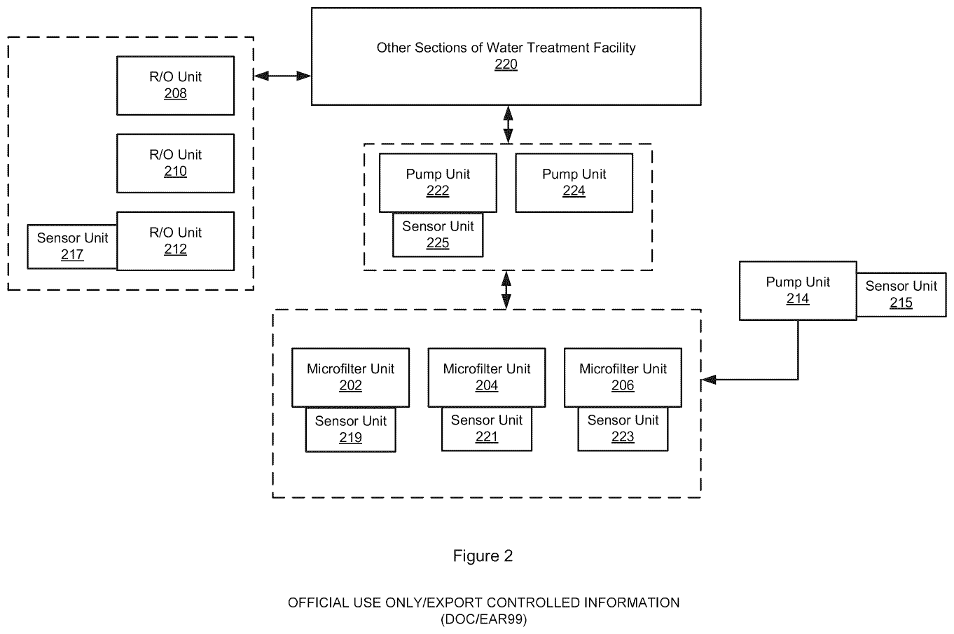

FIG. 2 depicts an example of a SPARC associated with a water treatment facility according to one aspect of the present embodiments. A water treatment facility may include a pump unit 214 that feeds the microfilter units 202-206. The pump units 222-224 may transport liquid between the microfilter units 202-206 and other sections of water treatment facility 220. In some embodiments, reverse osmosis (R/O) units 208-212 may also be connected to the other sections of water treatment facility 220. In this nonlimiting example, the SPARC may be deployed to monitor the operation of the pump unit 214, the pumps (not shown) associated with the microfilter units 202-206, the pump unit 222, and the pump (not shown) associated with the RIO unit 212. As such, a sensor unit 215 may be a sensor configured to detect vibrations and may be positioned within the same vicinity as the pump unit 214 (in this example, it may be physically connected, e.g., using adhesive, to the pump unit 214). As such, vibrations resulting from pump unit 214 may be detected by sensor unit 215. Similarly, sensor units 219, 221, and 223 may be configured to detect vibrations and may be positioned within the same vicinity as the pumps associated with the microfilter units 202, 204, and 206 respectively. Similarly, a sensor unit 225 may be configured to detect vibrations and may be positioned within a same vicinity as the pump unit 222 while the sensor unit 217 is configured to detect vibrations and is positioned within a same vicinity as the pump associated with the R/O unit 212. Accordingly, vibration associated with various components/processes may be detected that may or may not be the same as data provided by SCADA. As such, the monitored data can be used as an independent verification to detect one or more anomalies, as described above. It is appreciated that the number of sensor units shown is for illustrative purposes and should not be construed as limiting the scope of the embodiments. For example, fewer or more sensors may be used. Moreover, it is appreciated that in this nonlimiting example, not all R/O units or pump units have their own respective sensor for illustrative purposes. For example, in some embodiments each R/O unit and/or each pump unit may have its own corresponding sensor unit. Additionally, it is appreciated that in some nonlimiting examples more than one sensor unit per unit that is monitored may be used. For example, R/O unit 212 may be monitored using more than one sensor in some examples.

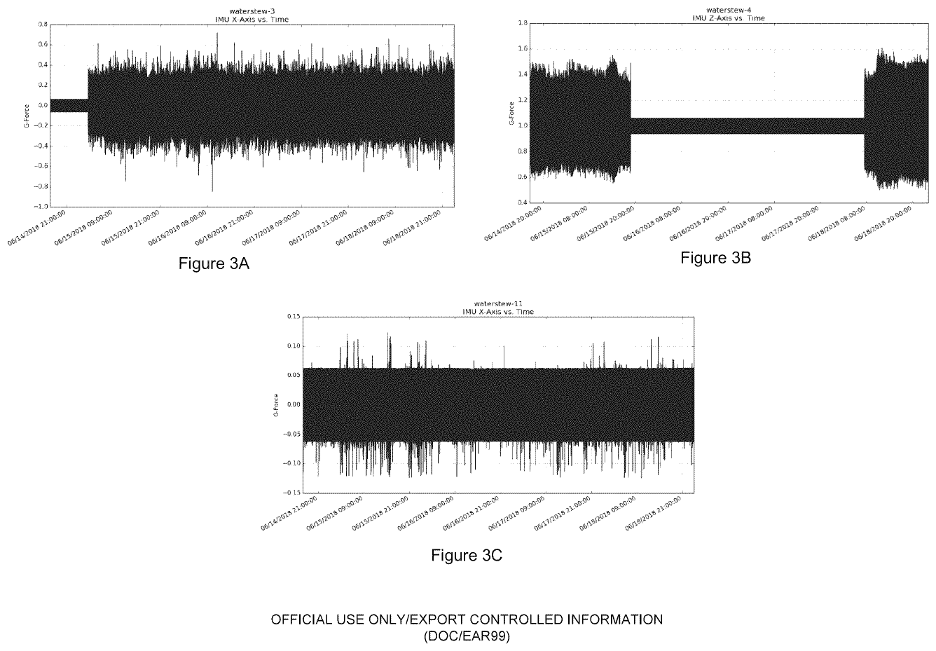

Referring now to FIGS. 3A-3C, an example of monitored ground truth in a water treatment facility according to one aspect of the present embodiments is shown. FIG. 3A illustrates the vibrations that are monitored and detected by sensor unit 219 which is associated with microfilter unit 202. The monitored data from sensor unit 219 illustrates that microfilter unit 202 is not in use early on before being utilized later. Referring now to FIG. 3B vibrations monitored by sensor unit 217 are illustrated. The sensor unit 217 detects vibrations associated with the pump associated with the R/O unit 212 illustrating that the R/O unit 212 has not been in use for three days. Referring now to FIG. 3C, the monitored vibrations by sensor unit 215 that is associated with the pump unit 214 is shown. In this nonlimiting example, sensor unit 215 illustrates that the pump unit 214 has been operating continuously.

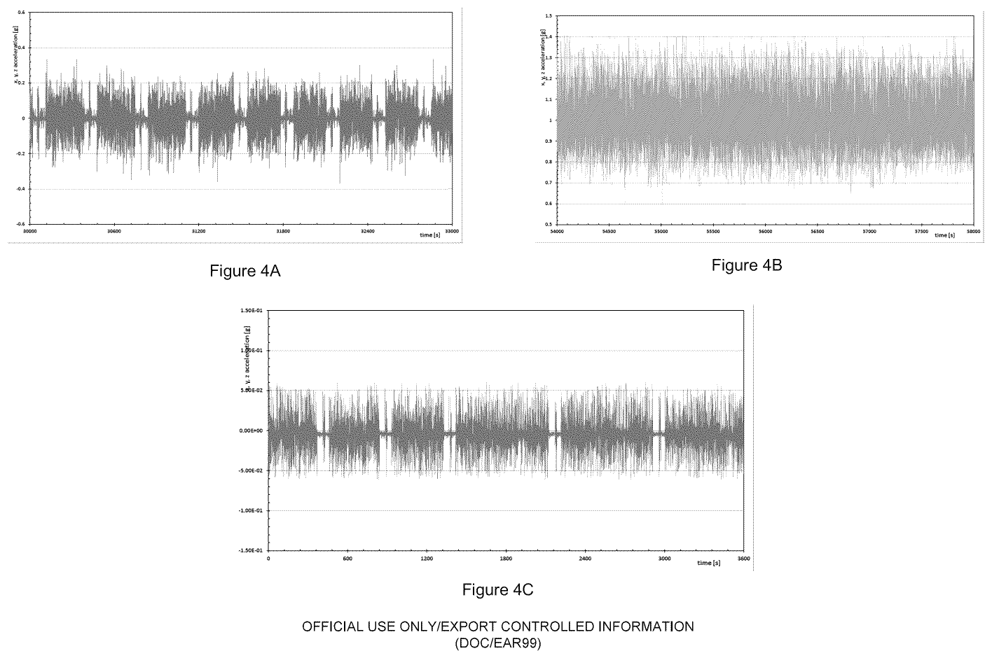

Referring now to FIGS. 4A-4C, a detailed example of the monitored ground truth of FIGS. 3A-3C according to one aspect of the present embodiments is shown. FIGS. 4A-4C are detailed data associated with FIGS. 3A-3C, e.g., illustrating the monitored data during 1 hour of operation.

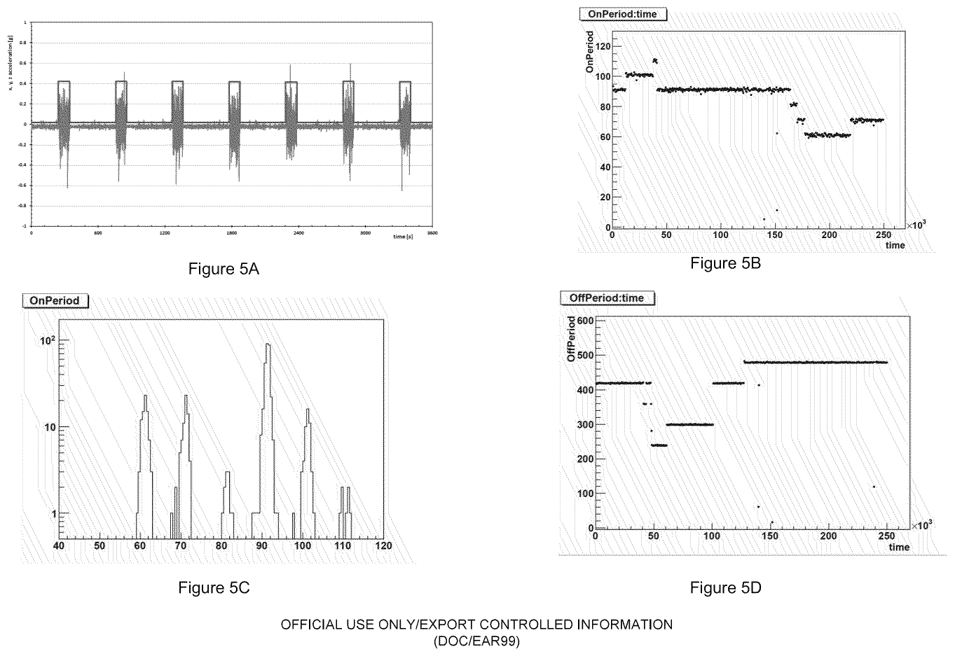

Referring now to FIGS. 5A-5D, yet another example of monitored ground truth in a water treatment facility according to one aspect of the present embodiments is shown. Referring specifically to FIG. 5A, monitored data associated with the sensor unit 225 that detects vibrations associated with the pump unit 222 is shown. The pump unit 222 feeds fluid from the microfilter units 202, 204, and 206 into the concentration tank within the other sections of water treatment facility 220. As illustrated, sensor unit 225 detects vibrations in a regular pattern on/off. As such, detecting an atypical or unexpectedly different pattern may be an indication of cyberattack, malfunction, etc. Referring now to FIGS. 5B-5D illustrate further collected data during the “on” period and “off” period effectively defining “allowed” states of the process (e.g., pump unit 222 never performs with individual ON periods being shorter than 60 seconds or longer than 110 seconds). It is appreciated that FIG. 5C illustrates a nonlimiting example (histogram) of periods of when a process element is ON. Accordingly, the on/off pattern for a particular unit for a given period of time may be identified/determined.

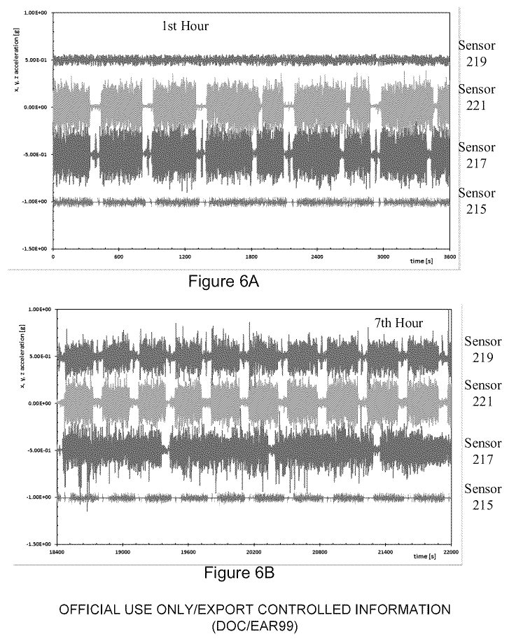

Referring now to FIGS. 6A-6B, an example of monitored ground truth associated with different processes in a water treatment facility according to one aspect of the present embodiments is shown. FIGS. 6A-6B illustrate the monitored data by sensor units 219, 221, 217, and 215 for the first hour of operation and the seventh hour of operation respectively. The monitored data as provided by the sensor units 219, 221, 217, and 215 may be used as a confirmation that each microfilter unit 202, 204, and 206 has its own pump unit while the pump unit 214 feeds all three microfilter units 202, 204, and 206. In one nonlimiting example, the relationship between the different units, e.g., microfilter units 202, 204, 206, and pump unit 214, can be deduced. For example, the pump unit 214 is on when the microfilter unit 206 and the microfilter unit 204 are on. Moreover, the pump unit 214 is on when either the microfilter unit 206 or the microfilter unit 202 is on. Accordingly, anomalies may be detected if there is a mismatch between data provided by SCADA and the data monitored by the SPARC. Moreover, data provided by SPARC can be used as an early warning for an operator to investigate or take necessary steps to address one or more issues. It is appreciated that as illustrated in FIGS. 6A-6B, the SPARC allows monitoring process elements and correlating them with one another if they depend on one another and further if they function independent from one another.

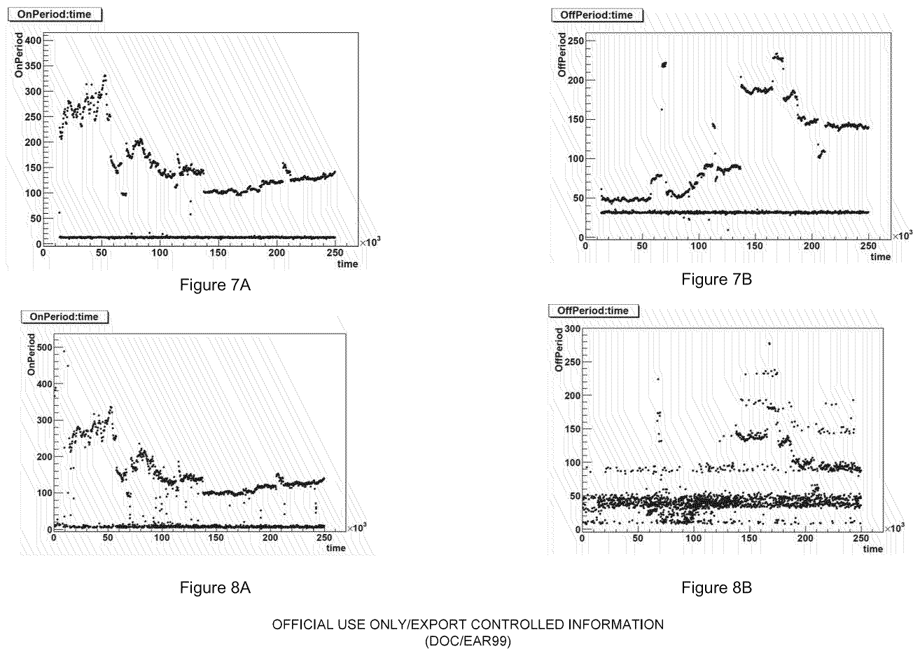

Referring now to FIGS. 7A-7B, an example of monitored ground truth (On/Off) associated with one process in a water treatment facility according to one aspect of the present embodiments is shown. In this nonlimiting example, monitored activity by sensor unit 219 associated with microfilter unit 202 is shown and reflects gradually changing demand on microfilter unit 202 performance by the operator. Accordingly, the SPARC may be used by an operator to implicitly monitor the changing requirements of process element(s) performance in time.

FIGS. 8A-8B show another example of monitored ground truth (On/Off) associated with another process in a water treatment facility according to one aspect of the present embodiments. In this nonlimiting example, monitored activity by sensor unit 215 associated with the pump unit 214 is shown and reflects gradually changing demand on pump unit 214 performance by the operator.

Accordingly, a network of non-intrusive and passive sensors may be used to monitor ground truth data associated with an entire facility. The SPARC may be deployed in various industrial setting such as chemical sector, commercial facilities sector, communications sector, critical manufacturing sector, dams sector, defense industrial base sector, emergency services sector, energy sector, financial services sector, food and agriculture sector, government facilities sector, healthcare and public health sector, information technology sector, nuclear reactors/materials/waste sector, transportation systems sector, water/wastewater systems sector, etc. As such, the discussions with respect to the water treatment plant, described above, are for illustration purposes and should not be construed as limiting the scope of the embodiments. As illustrated in the examples above, the SCADA 160 may illustrate that a pump is on because SCADA 160 has turned on the pump but in reality an intruder may have disconnected the pump which may not be detected by SCADA 160 (unless if there is a flow detector as an example), however, leveraging the SPARC system the fact that the pump is not on is detected. Comparison of the data from SPARC and SCADA may trigger the administrator to investigate the situation and to detect a possible intrusion or malicious act.

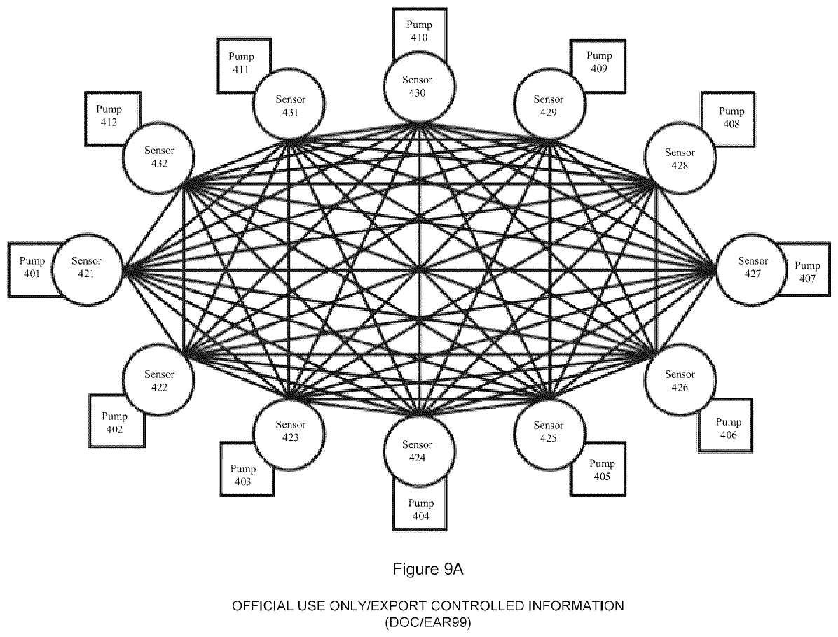

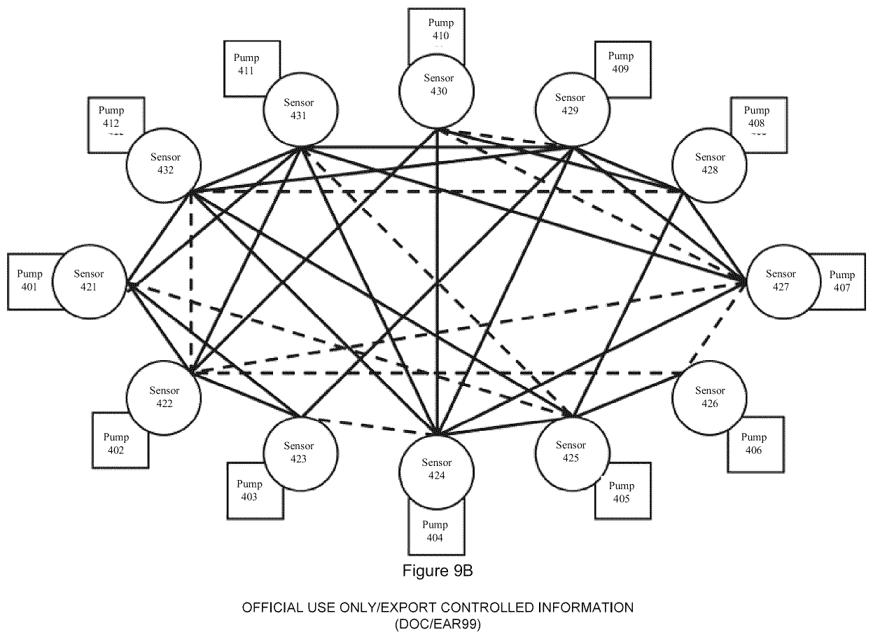

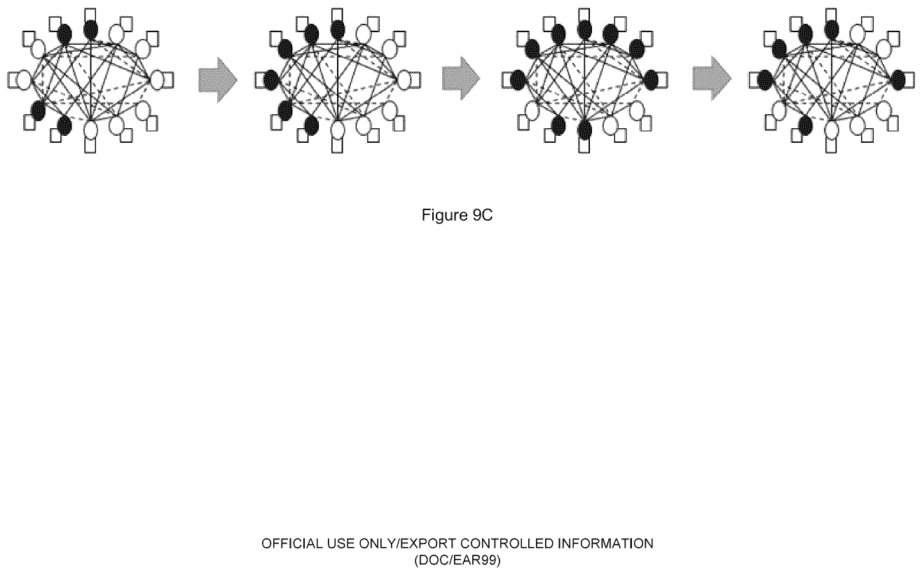

In some embodiments, supervised learning is used such that known input data, a weighted matrix, and known output data are used to gradually adjust the model to accurately compute the already known output. Once the model is trained (e.g., as described in FIGS. 1A-8B), i.e., calibrated model is generated, field data is applied as input, e.g., data from SCADA, monitored data by non-intrusive sensors, etc., and a predicted anomalies output, e.g., process malfunction, intrusion, cyberattack, etc., is determined. In other embodiments, where the input data has not yet been confirmed, unstructured learning is used such that a model attempts to reconstruct known input data over time in order to learn. FIG. 9 is described as a structured learning model for depiction purposes and is not intended to be limiting.

Some embodiments leverage unsupervised machine learning to learn patterns of individual sensors in order to characterize the status of the equipment being monitored by that particular sensor. Once these characterizations are numerically described (either binary for on/off or continuously) they are used to train a neural network depicted in FIG. 9A via unsupervised learning. Each sensor (sensors 421-432) may be represented as a node or circle in FIG. 9A, measuring the behavior of some equipment (12 pumps 401-412 in this example) indicated by squares. There are potential connections between all pairs of nodes to quantify the relationship between equipment within the facility. Once learned from the data, these connections describe how much the given sensor's status can be predicted by the other nodes. The final trained network characterizes the relationship between equipment in the facility. FIG. 9B illustrates a trained network where solid connections between nodes indicate that the equipment measured by those sensors tend to exist in the same state (either both on or both off) while dashed connections indicate sensors that tend to exist in opposite states (one on, the other off). For instance, in this example if Pump 406 is running, then Pump 405 is expected to be running and for Pumps 407 and 402 to be inactive.

Once the overall system is characterized by the relationships between equipment, some embodiments may facilitate detection of anomalies based on (a) consistency of a given state based on these relationships and (b) frequency of the system transitioning into a given state based on the past system statuses. An example of the predictive power of some embodiments is demonstrated in FIG. 9C where nodes that are filled in indicate that the sensor reads that the pump is active. Given an initial state shown on the left, the system tends to move into the next state shown where two additional pumps have turned on. Using this process, a Discrete Time Markov Chain can describe the likelihood of the system transitioning from one configuration of individual equipment behaviors to a new configuration. Using the sensor-level network and the system-level networks, anomalous behavior can be detected in real-time without reliance on the SCADA.

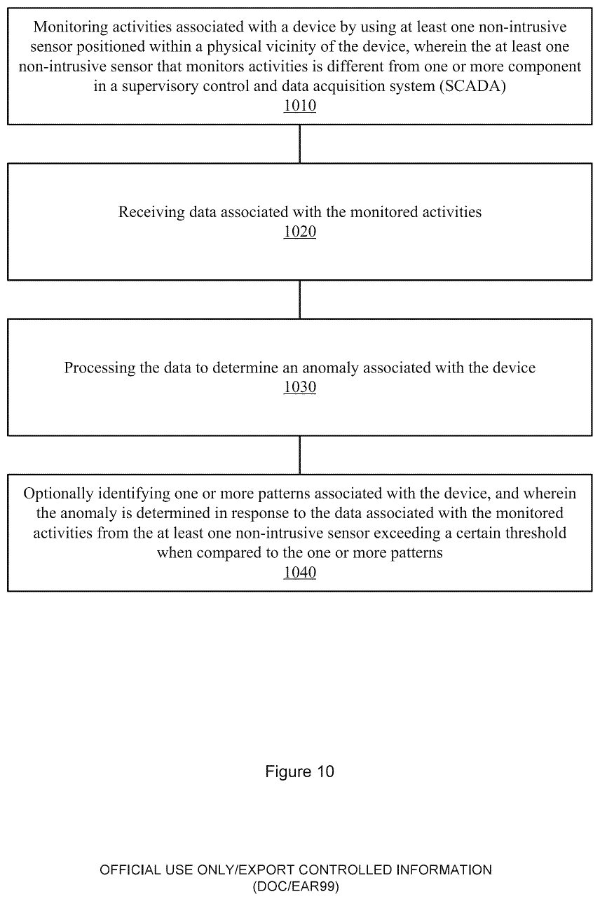

Referring now to FIG. 10, a flow diagram for processing data in a SPARC system according to one aspect of the present embodiments is shown. At step 1010, activities associated with a device is monitored by using at least one non-intrusive sensor positioned within a physical vicinity of the device. It is appreciated that the device is controlled by a device other than the at least one non-intrusive sensor. The monitored activities may include one or more of position, presence, proximity, motion, velocity, displacement, temperature, humidity, moisture, acoustic, sound vibration, chemical sensing, gas sensing, liquid flow, force sensing, load sensing, torque sensing, strain sensing, pressure sensing, leaks, threshold levels, electric charges/fields, magnetic fields, acceleration, tilt, radiation, optical sensing, etc. It is appreciated that at least one non-intrusive sensor that monitors activities is different from one or more components in a SCADA. At step 1020, data associated with the monitored activities is received. At step 1030, the data is processed to determine an anomaly (e.g., a physical intrusion to a facility housing the device, a cyberattack, a malfunction with the device, etc.) associated with the device. In one nonlimiting example, the anomaly is determined in response to a difference between the data associated with the monitored activities from the at least one non-intrusive sensor and data from the SCADA exceeding a threshold. It is appreciated that in some embodiments, the method may further include comparing a machine learning model associated with the device to the data associated with the monitored activities from the at least one non-intrusive sensor to determine the anomaly based on deviation therefrom. At optional step 1040, one or more patterns associated with the device may be identified. It is appreciated that the anomaly may be determined in response to the data associated with the monitored activities from the at least one non-intrusive sensor exceeding a certain threshold when compared to the one or more patterns. It is appreciated that according to some embodiments, the at least one non-intrusive sensor is configured to sense vibration, and wherein the sensor is physically coupled to the device and wherein the sensor detects vibration in response to the device turning on.

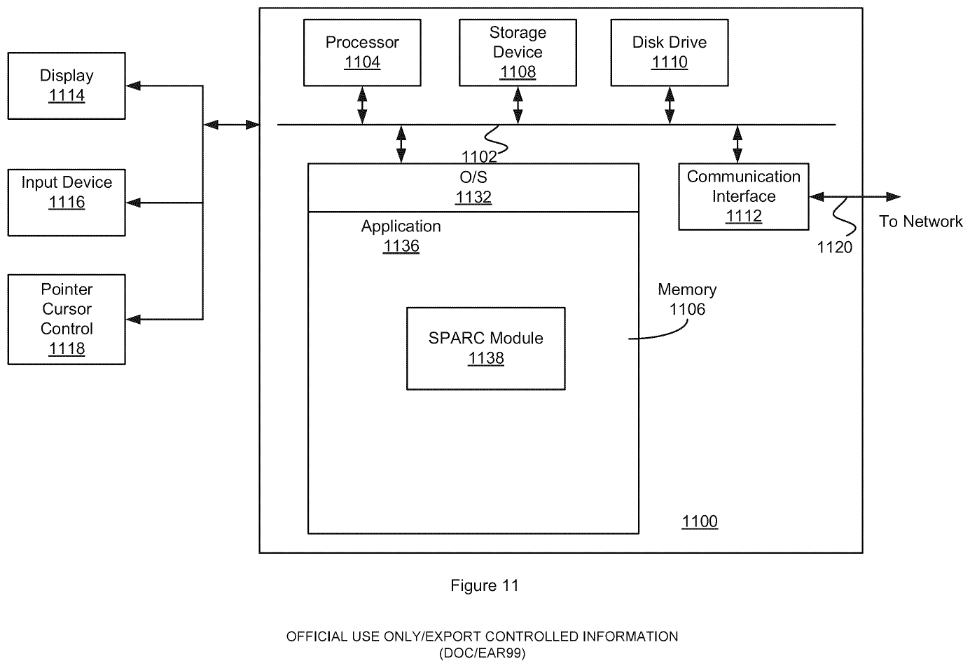

FIG. 11 is a block diagram depicting an example of a computer system suitable for processing data in a SPARC system in accordance with some embodiments. In some examples, computer system 1100 can be used to implement computer programs, applications, methods, processes, or other software to perform the above-described techniques and to realize the structures described herein. Computer system 1100 includes a bus 1102 or other communication mechanism for communicating information, which interconnects subsystems and devices, such as a processor 1104, a system memory (“memory”) 1106, a storage device 1108 (e.g., ROM), a disk drive 1110 (e.g., magnetic or optical), a communication interface 1112 (e.g., modem or Ethernet card), a display 1114 (e.g., CRT or LCD), an input device 1116 (e.g., keyboard), and a pointer cursor control 1118 (e.g., mouse or trackball). In one embodiment, pointer cursor control 1118 invokes one or more commands that, at least in part, modify the rules stored, for example in memory 1106, to define the electronic message preview process.

According to some examples, computer system 1100 performs specific operations in which processor 1104 executes one or more sequences of one or more instructions stored in system memory 1106. Such instructions can be read into system memory 1106 from another computer readable medium, such as static storage device 1108 or disk drive 1110. In some examples, hard-wired circuitry can be used in place of or in combination with software instructions for implementation. In the example shown, system memory 1106 includes modules of executable instructions for implementing an operating system (“OS”) 1132, an application 1136 (e.g., a host, server, web services-based, distributed (i.e., enterprise) application programming interface (“API”), program, procedure or others). Further, application 1136 includes a SPARC module 1138 that includes executable instructions for monitoring and capturing data from one or more non-intrusive and passive sensors and to process that data in order to identify an anomaly, if any, as described above with respect to FIGS. 1A-10. In some embodiments, the SPARC module 1138 may further receive data from SCADA in order to compare data received from the non-intrusive sensors and determine and identify one or more anomalies, if any. It is appreciated that in some embodiments, the SPARC module 1138 may leverage the power of machine learning in order to identify patterns and to identify one or more anomalies.

The term “computer readable medium” refers, at least in one embodiment, to any medium that participates in providing instructions to processor 1104 for execution. Such a medium can take many forms, including but not limited to, non-volatile media, volatile media, and transmission media. Non-volatile media includes, for example, optical or magnetic disks, such as disk drive 1110. Volatile media includes dynamic memory, such as system memory 1106. Transmission media includes coaxial cables, copper wire, and fiber optics, including wires that comprise bus 1102. Transmission media can also take the form of acoustic or light waves, such as those generated during radio wave and infrared data communications.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 1100. According to some examples, two or more computer systems 1100 coupled by communication link 1120 (e.g., LAN, PSTN, or wireless network) can perform the sequence of instructions in coordination with one another. Computer system 1100 can transmit and receive messages, data, and instructions, including program code (i.e., application code) through communication link 1120 and communication interface 1112. Received program code can be executed by processor 1104 as it is received, and/or stored in disk drive 1110, or other non-volatile storage for later execution. In one embodiment, system 1100 is implemented as a hand-held device. But in other embodiments, system 1100 can be implemented as a personal computer (i.e., a desktop computer) or any other computing device. In at least one embodiment, any of the above-described delivery systems can be implemented as a single system 1100 or can implemented in a distributed architecture including multiple systems 1100.

In other examples, the systems, as described above can be implemented from a personal computer, a computing device, a mobile device, a mobile telephone, a facsimile device, a personal digital assistant (“PDA”) or other electronic device.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Alternatively, the elements and their functionality can be subdivided into constituent sub-elements, if any. As software, the above-described techniques can be implemented using various types of programming or formatting languages, frameworks, syntax, applications, protocols, objects, or techniques, including C, Objective C, C++, C #, Flex™, Fireworks®, Java™, Javascript™, AJAX, COBOL, Fortran, ADA, XML, HTML, DHTML, XHTML, HTTP, XMPP, and others. These can be varied and are not limited to the examples or descriptions provided.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system comprising:
a plurality of non-intrusive sensors configured to monitor activities associated with one or more devices, wherein at least one non-intrusive sensor of the plurality of non-intrusive sensors is positioned within a physical vicinity of the one or more devices;
an access point device communicatively coupled to the plurality of non-intrusive sensors, wherein the access point device is configured to receive data associated with the monitored activities from the plurality of non-intrusive sensors and further to transmit the data associated with the monitored activities to a computing device for processing; and
the computing device configured to receive the data associated with the monitored activities and process the data to determine an anomaly associated with the one or more devices.

2. The system of claim 1, wherein the plurality of non-intrusive sensors that capture data associated with the monitored activities is different from one or more components in a supervisory control and data acquisition system (SCADA).

3. The system of claim 2, wherein the computing device determines the anomaly in response to a difference between the data associated with the monitored activities from the plurality of non-intrusive sensors and data from the SCADA exceeding a threshold.

4. The system of claim 1, wherein a sensor of the plurality of non-intrusive sensors is configured to sense one or more of position, presence, proximity, motion, velocity, displacement, temperature, humidity, moisture, acoustic, sound vibration, chemical sensing, gas sensing, liquid flow, force sensing, load sensing, torque sensing, strain sensing, pressure sensing, leaks, threshold levels, electric charges/fields, magnetic fields, acceleration, tilt, radiation, and optical sensing.

5. The system of claim 1, wherein the computing device is configured to compare a machine learning model associated with the one or more devices to the data associated with the monitored activities from the plurality of non-intrusive sensors to determine the anomaly based on deviation therefrom.

6. The system of claim 1 further comprising a supervisory control and data acquisition system (SCADA) configured to provide data separately from the data associated with the monitored activities from the plurality of non-intrusive sensors.

7. The system of claim 1, wherein the computing device is configured to identify one or more patterns associated with the one or more devices, and wherein the computing device determines the anomaly in response to the data associated with the monitored activities from the plurality of non-intrusive sensors exceeding a certain threshold when compared to the one or more patterns.

8. The system of claim 1, a sensor of the plurality of non-intrusive sensors is configured to sense vibration, and wherein the sensor is physically coupled to the one or more devices and wherein the sensor detects vibration in response to the one or more devices turning on.

9. The system of claim 1, wherein the plurality of non-intrusive sensors is configured to monitor the one or more devices and wherein the one or more devices are controlled by a device other than the plurality of non-intrusive sensors.

10. The system of claim 1, wherein the anomaly is physical intrusion to a facility housing the one or more devices.

11. The system of claim 1, wherein the anomaly is a cyberattack.

12. The system of claim 1, wherein the anomaly is a malfunction associated with the one or more devices.

13. A method comprising:
monitoring activities associated with a device by using at least one non-intrusive sensor positioned within a physical vicinity of the device, wherein the at least one non-intrusive sensor that monitors activities is different from one or more components in a supervisory control and data acquisition system (SCADA);
receiving data associated with the monitored activities; and
processing the data to determine an anomaly associated with the device.

14. The method of claim 13, wherein the anomaly is determined in response to a difference between the data associated with the monitored activities from the at least one non-intrusive sensor and data from the SCADA exceeding a threshold.

15. The method of claim 13, wherein the activities include one or more of position, presence, proximity, motion, velocity, displacement, temperature, humidity, moisture, acoustic, sound vibration, chemical sensing, gas sensing, liquid flow, force sensing, load sensing, torque sensing, strain sensing, pressure sensing, leaks, threshold levels, electric charges/fields, magnetic fields, acceleration, tilt, radiation, and optical sensing.

16. The method of claim 13 further comprising comparing a machine learning model associated with the device to the data associated with the monitored activities from the at least one non-intrusive sensor to determine the anomaly based on deviation therefrom.

17. The method of claim 13 further comprising identifying one or more patterns associated with the device, and wherein the anomaly is determined in response to the data associated with the monitored activities from the at least one non-intrusive sensor exceeding a certain threshold when compared to the one or more patterns.

18. The method of claim 13, wherein the at least one non-intrusive sensor is configured to sense vibration, and wherein the sensor is physically coupled to the device and wherein the sensor detects vibration in response to the device turning on.

19. The method of claim 13, wherein the device is controlled by a device other than the at least one non-intrusive sensor.

20. The method of claim 13, wherein the anomaly is one or more of a physical intrusion to a facility housing the device, a cyberattack, or a malfunction with the device.
